(19) United States
(12) Patent Application Publication
(10) Pub. No.: US 2024/0386607 A1
(43) Pub. Date: Nov. 21, 2024

(54) METHOD FOR DETERMINING AN OPTICAL AXIS OF A MAIN OBSERVER CAMERA OF A MEDICAL MICROSCOPE ARRANGEMENT IN A REFERENCE COORDINATE SYSTEM, AND MEDICAL MICROSCOPE ARRANGEMENT

(71) Applicant: Carl Zeiss Meditec AG, Jena (DE)

(72) Inventor: Richard Bäumer, Urbach (DE)

(21) Appl. No.: 18/784,873

(22) Filed: Jul. 25, 2024

Related U.S. Application Data
(63) Continuation of application No. PCT/EP2023/051681, filed on Jan. 24, 2023.

(30) Foreign Application Priority Data
Jan. 25, 2022 (DE) 10 2022 200 823.5

(51) Int. Cl. G06T 7/73; G02B 21/00; G02B 21/36; H04N 23/69; H04N 23/695

(52) U.S. Cl. CPC G06T 7/74; G02B 21/0012; G02B 21/365; H04N 23/69; H04N 23/695; G06T 2207/10056; G06T 2207/30204; G06T 2207/30244

(57) ABSTRACT

A method for determining an optical axis of a main observer camera of a medical microscope arrangement in a reference coordinate system includes capturing a capture region with a main observer camera and at least partly with an environment camera. The environment camera is configured to track objects and its coordinate system or a coordinate system of an optical marker forms the reference coordinate system. A test object is captured at at least one working distance where a neutral point of a zoom system of the main observer camera is determined in the coordinate system of the environment camera by capturing and evaluating image representations of the test object at different magnifications. The optical axis is determined proceeding from the neutral point. At least one item of descriptive information describing the determined optical axis in the reference coordinate system is generated and provided. Furthermore, a medical microscope arrangement is provided.

### CROSS REFERENCE TO RELATED APPLICATIONS

This application is a continuation application of international patent application PCT/EP2023/051681, filed Jan. 24, 2023, designating the United States and claiming priority to German application 10 2022 200 823.5, filed Jan. 25, 2022, and the entire content of both applications is incorporated herein by reference.

### TECHNICAL FIELD

The disclosure relates to a method for determining an optical axis of a main observer camera of a medical microscope arrangement in a reference coordinate system, and a medical microscope arrangement.

### BACKGROUND

The extrinsic calibrations of cameras influence the quality of tracking of objects in a capture region of a medical microscope and the environment thereof (tracking quality). This tracking quality is important for example for instrument tracking functionalities or for tracking patients and subsequent data overlay of preoperatively captured data. The extrinsic calibrations involve determining relative poses (relative positions and relative rotations) between coordinate systems of the cameras with respect to one another. When two or more camera systems are used, it is therefore necessary to determine the (relative) pose of the cameras as accurately as possible.

In this case, a medical microscope may include a main observer camera for capturing a capture region and an environment camera for capturing the capture region and an environment of the capture region. The main observer camera captures the surgical procedure, which can subsequently be represented in a magnified manner and/or in a manner enhanced with additional information. In this case, the environment camera serves for tracking objects in the capture region and in the environment (object tracking). In order to correlate objects tracked by the environment camera with image representations of the main observer camera, it is necessary to know the (relative) pose between the main observer camera and the environment camera as accurately as possible. Even small angular errors around the two axes perpendicular to the optical axis in the knowledge of the pose of an optical axis of the main observer camera may lead to disturbing deviations (an angular error of 1° at a working distance of 500 mm corresponds to a deviation of approximately 8.7 mm).

It is therefore desirable to capture the relative pose as accurately as possible or, to put it another way, to know the optical axis of the main observer camera in the coordinate system of the environment camera as accurately as possible.

### SUMMARY

It is an object of the disclosure to provide a method and a medical microscope arrangement which can be used to determine an optical axis of a main observer camera of the medical microscope arrangement in a reference coordinate system.

The object is achieved by a method for determining an optical axis of a main observer camera of a medical microscope arrangement in a reference coordinate system and by a medical microscope arrangement as described herein.

A fundamental concept of the disclosure is that of determining a pose of the optical axis of the main observer camera with the aid of a zoom system of the medical microscope arrangement. This involves capturing and evaluating image representations of a test object at different magnification levels of the zoom system at at least one working distance. In parallel therewith, an environment camera captures the test object arranged in the capture region and tracks the test object, as a result of which a position of the test object and/or of features of the test object in the coordinate system of the environment camera is known. It may be sufficient for the environment camera to only partly capture the capture region. In particular, the environment camera completely captures the capture region. Proceeding from the captured image representations of the main observer camera, at the at least one working distance a neutral point of the zoom system is determined in the coordinate system of the environment camera. In this case, the neutral point is the point which coincides with an optical axis of the zoom system. The neutral point is therefore the point and/or region in the image representations which ideally do(es) not move across the different magnification levels. The optical axis of the main observer camera, for at least two working distances, is then determined proceeding from the neutral point determined in the coordinate system of the environment camera at the at least one working distance. In this case, the determined optical axis is an estimation for positions of the (real) optical axis in the coordinate system of the environment camera, that is to say in the reference coordinate system. Alternatively, a coordinate system of an optical marker can also be chosen as the reference coordinate system provided that a relationship between the coordinate system of the optical marker and the coordinate system of the environment camera is known or can be determined. Furthermore, at least one item of descriptive information describing the determined optical axis in the reference coordinate system is generated and provided, for example as an analog or digital signal, for example as a data packet.

In particular, a method for determining an optical axis of a main observer camera of a medical microscope arrangement in a reference coordinate system is provided, wherein a capture region is captured with a main observer camera, and wherein the capture region is at least partly captured and an environment of the capture region is captured with an environment camera, wherein the environment camera is used for tracking objects and its coordinate system or a coordinate system of an optical marker forms the reference coordinate system, wherein a test object is captured at at least one working distance with the main observer camera and the environment camera, wherein at the at least one working distance a neutral point of a zoom system of the main observer camera is determined in the coordinate system of the environment camera, wherein this is done by capturing and evaluating image representations of the test object at different magnifications of the zoom system at the at least one working distance, wherein the optical axis of the main observer camera is determined proceeding from the neutral point determined in the coordinate system of the environment camera at the at least one working distance, and wherein at least one item of descriptive information describing the determined optical axis in the reference coordinate system is generated and provided.

Furthermore, in particular, a medical microscope arrangement is provided, including a main observer camera having a zoom system, configured to capture a capture region, and an environment camera, configured to at least partly capture the capture region and an environment of the capture region, wherein the environment camera is used for tracking objects and its coordinate system or a coordinate system of an optical marker forms a reference coordinate system, furthermore an actuator system, configured for moving at least the main observer camera, and a control device, wherein the control device is configured to instigate capturing of a test object at at least one working distance with the main observer camera and the environment camera, and for this purpose to control the actuator system and the zoom system of the main observer camera in such a way that at the at least one working distance a neutral point of the zoom system of the main observer camera can be determined in the coordinate system of the environment camera by capturing and evaluating image representations of the test object at different magnifications of the zoom system; to determine the optical axis of the main observer camera proceeding from the neutral point determined at the at least one working distance in the coordinate system of the environment camera; and to generate and provide at least one item of descriptive information describing the determined optical axis in the reference coordinate system.

An advantage of the method and the medical microscope arrangement is that the optical axis of the main observer camera can be determined at any time in the reference coordinate system, that is to say the coordinate system of the environment camera. As a result, in particular, a (relative) pose of the main observer camera in the reference coordinate system is known (with the exception of a relative rotation with respect to one another). Since, as a result, the relative pose between the main observer camera and the environment camera used for tracking objects can always be kept up-to-date even in the field, a quality of a tracking of objects and of an overlay-generated on the basis thereof-of additional information (object information, object positions, etc.) over captured image representations of the main observer camera can be improved. In particular, the cameras can be (extrinsically) recalibrated with respect to one another in this way.

A medical microscope arrangement is a surgical microscope, in particular. However, a medical microscope arrangement can also be a microscope used for medical examinations and/or for diagnostic purposes, for example in the field of ophthalmology. The medical microscope arrangement is a digital microscope and/or a stereoscopic medical microscope, in particular. In a manner known per se, the medical microscope arrangement includes a control device configured to control components of the medical microscope arrangement, an input device for operation, and a display device configured to display captured image representations. The medical microscope arrangement can also include a tracking system. An environment camera can be part of such a tracking system.

Parts of the medical microscope arrangement, in particular the control device, can be configured, either individually or together, as a combination of hardware and software, for example as program code that is executed on a microcontroller or microprocessor. However, provision can also be made for parts to be configured, either individually or together, as an application-specific integrated circuit (ASIC) and/or a field-programmable gate array (FPGA).

Determining the optical axis of the main observer camera proceeding from the neutral point(s) determined in the coordinate system of the environment camera takes place in particular with the aid of at least one known feature and/or on the test object. In particular, at least one feature is recognized both in an image representation captured with the environment camera and in an image representation captured with the main observer camera at the same working distance. In this case, it is possible to use feature and pattern recognition methods known per se, for example known methods of computer vision and/or artificial intelligence (in particular machine learning). If the determined neutral point can be localized based on the at least one feature with reference to the test object, then a position of the neutral point in the coordinate system of the environment camera and thus in the reference coordinate system can be determined by way of this reference point. Proceeding from the neutral point determined at the at least one working distance, assuming a constant position of this neutral point in relation to an image sensor of the main observer camera, a position of the optical axis can be determined, in particular estimated, at other working distances as well. If neutral points are determined by way of a respective zoom center at at least two working distances, these neutral points determined at the at least two working distances then (directly) define points of the optical axis of the main observer. Determining the neutral point and/or the position of the optical axis can also take place by way of the at least one feature described above and/or on the test object, provided that a relative relationship can be determined between the at least one feature and the neutral point at a working distance in the image representation respectively captured. In particular, a transformation between a coordinate system of the main observer camera and the environment camera can take place in a manner mediated by way of the at least one feature.

Provision can furthermore be made for the following method steps to be carried out based on the method described in this disclosure: As described, a neutral point is determined based on the image representations of the test object captured at different magnifications of the zoom system (at at least one working distance). This neutral point is expressed for example in the form of image coordinates of the main observer camera (or of an image sensor of the main observer camera). In addition, a pose (position and orientation) of the test object in the reference coordinate system is determined with the environment camera. The poses of individual features on the test object are assumed to be known. Proceeding from a known (but under certain circumstances erroneous) calibration between the main observer camera and the environment camera, a feature recognition (in particular, a geometry and/or at least one feature of the test object being known) and a feature comparison in the captured image representations of the main observer camera, it is then possible to carry out a comparison as to whether features in the captured image representations have an expected offset with respect to the determined neutral point. If the actual offset does not correspond to the target offset, then a difference can be determined, and a pose of the optical axis can be determined proceeding from the determined difference. Proceeding from such a comparison, the descriptive information describing the optical axis in the reference coordinate system can be generated.

Provision can be made for the method also to be repeated for further main observer cameras and/or further environment cameras, the procedure being analogous in this case.

In particular, provision is made for the at least one item of descriptive information to be taken into account in an extrinsic calibration between a coordinate system of the main observer camera and the coordinate system of the environment camera. As a result, the extrinsic calibration can always be kept up-to-date and, if necessary, corrected.

In one exemplary embodiment, provision is made for the optical axis to be determined at at least one further working distance proceeding from the neutral point determined at the at least one working distance, on the basis of a pixel coordinate of the main observer camera that corresponds to this neutral point at the at least one working distance. As a result, a position of the optical axis can be determined, in particular estimated, at other working distances as well. In this exemplary embodiment, it is assume that the optical axis does not move or moves only negligibly in relation to the main observer camera (in particular in relation to an image sensor of the main observer camera). Once the associated pixel coordinate has been determined, then a position of the optical axis at other working distances can be determined by way of this. For example, a test object feature imaged at this pixel coordinate can be identified and used for determining the position in the coordinate system of the environment camera, as has already been explained above.

In one exemplary embodiment, provision is made for a test object to be captured at at least two working distances with the main observer camera and the environment camera, wherein at the at least two working distances a neutral point of a zoom system of the main observer camera is in each case determined in the coordinate system of the environment camera, wherein this is done by capturing and evaluating image representations of the test object at different magnifications of the zoom system at each of the working distances, wherein the optical axis of the main observer camera is determined proceeding from the neutral points determined in the coordinate system of the environment camera, and wherein at least one item of descriptive information describing the determined optical axis in the reference coordinate system is generated and provided.

In one exemplary embodiment, it is provided that for capturing purposes an actuator system of the medical microscope arrangement is controlled or regulated in such a way that a position of a model-based optical axis of the main observer camera at the at least one working distance is arranged at a distinguished position of the test object, wherein during the evaluating a difference between the distinguished position and the neutral point determined for the at least one working distance is determined and taken into account when generating the at least one item of descriptive information. As a result, positions of the model-based optical axis in the coordinate system of the environment camera (reference coordinate system) can be directly corrected by these being displaced by the determined difference. In this case, the model-based positions form the basis for the extrinsic calibration between the main observer camera and the environment camera, wherein the model data and/or model parameters are stored in the medical microscope arrangement, in particular in a memory of the control device, and can be retrieved from this memory as necessary.

In one exemplary embodiment, it is provided that image representations captured at the different magnifications at the at least one working distance for the purpose of determining the neutral point are superimposed, wherein the neutral point is determined as that point in the superimposed image representations which moves the least between the image representations. As a result, the neutral point can be determined in a particularly simple manner. In particular, in each of the captured image representations the same features can be determined at different magnification levels. If these same features are then each connected by straight lines, an intersection point of these straight lines coincides with the neutral point, in particular.

In one exemplary embodiment, it is provided that for the purpose of determining the neutral point, an optical flow between the image representations captured at the different magnifications at the at least one working distance is determined and evaluated, wherein the neutral point, proceeding from the determined optical flow, is determined as that point in the image representations which moves the least. This affords a further possibility of determining the neutral point. The optical flow between the image representations captured at different magnification levels is determined here by methods known per se.

In one exemplary embodiment, it is provided that neutral points determined for at least two working distances are connected with the aid of a line of best fit or a polynomial function, wherein the at least one item of descriptive information describing the optical axis includes parameters of the line of best fit or polynomial function. As a result, it is possible to estimate and provide a complete course of the optical axis over all working distances in the coordinate system of the environment camera (reference coordinate system).

In one exemplary embodiment, it is provided that positions on the optical axis for non-measured working distances are estimated by interpolation and/or extrapolation. As a result, values for a position of the optical axis in the coordinate system of the environment camera can also be provided for working distances at which no neutral point was determined or no comparison between the coordinate systems has taken place.

In one exemplary embodiment, provision is made for the test object to be displayed as a virtual test object on a display device. As a result, it is possible to dispense with a physical test object and an arrangement of the physical test object in the capture region of the cameras. In particular, provision is made for an actuator system of the medical microscope to be controlled with the control device in such a way that the display device is arranged in the capture regions of the cameras. To put it another way, the medical microscope arrangement is moved and/or pivoted in such a way that the cameras can capture the virtual test object displayed on the display device.

In one embodiment, provision is made for the test object to include a checkered pattern and/or a ChArUco pattern. As a result, features that can be recognized in a particularly simple manner can be provided. Determining the neutral points can be simplified and accelerated as a result.

In principle, the test object can also be or be formed by at least one arbitrary feature in the capture region of the main observer camera, for example an anatomical detail in the surgical site. For this purpose, it is merely necessary for this feature or detail to be visible and able to be identified and/or recognized (again) in the image representations captured at the different magnification levels.

In one exemplary embodiment, provision is made for a position of the neutral point at a working distance to be monitored at least in the manner of random sampling during use of the zoom system. As a result, positions of the optical axis of the main observer camera and thus an extrinsic calibration can also be monitored and if necessary corrected during regular operation. The measures are then implemented in an analogous manner, the test object being in particular an object which is arranged in the capture region and on which at least one feature is recognized, and the position thereof is evaluated for determining the neutral point.

### BRIEF DESCRIPTION OF THE DRAWINGS

The disclosure will now be described with reference to the drawings wherein:

FIG. 1 shows a schematic illustration of the medical microscope arrangement according to an exemplary embodiment of the disclosure;

FIG. 2 shows a schematic illustration of the medical microscope arrangement for elucidating the method according to a further exemplary embodiment of the disclosure;

FIG. 3 shows a schematic flowchart of the method for determining an optical axis of a main observer camera of a medical microscope arrangement in a reference coordinate system according to an exemplary embodiment of the disclosure;

FIG. 4 shows a schematic flowchart of a further embodiment of the method for determining an optical axis of a main observer camera of a medical microscope arrangement in a reference coordinate system; and

FIG. 5 shows a schematic illustration of the medical microscope arrangement according to a further exemplary embodiment of the disclosure.

### DESCRIPTION OF EXEMPLARY EMBODIMENTS

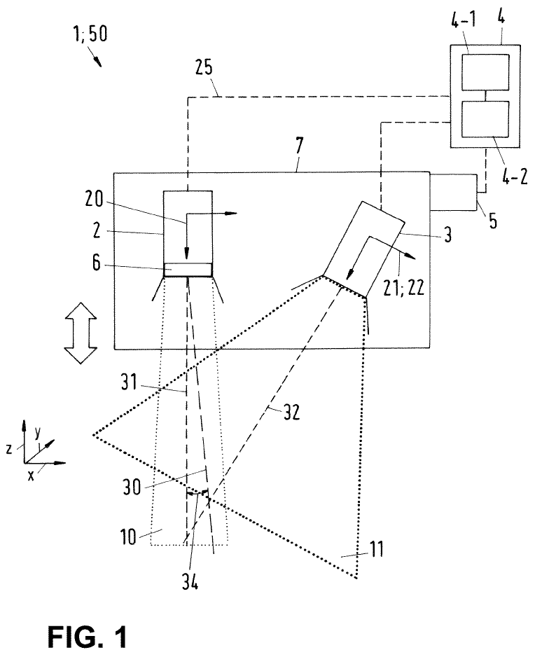

FIG. 1 shows a schematic illustration of the medical microscope arrangement 50 in the form of a medical microscope 1 according to an exemplary embodiment of the disclosure. The medical microscope 1 includes a main observer camera 2, an environment camera 3 and a control device 4. A medical microscope 1 is a surgical microscope. However, a medical microscope 1 can also be a microscope used for medical examinations and/or for diagnostic purposes, for example in the field of ophthalmology. The method described in this disclosure is explained in greater detail below on the basis of the medical microscope 1.

The main observer camera 2 is configured to capture a capture region 10. The main observer camera 2 has a coordinate system 20. During operation of the medical microscope 1, the main observer camera 2 serves to capture a surgical area, such that the captured surgical area can be displayed in a magnified manner and/or in a manner enhanced with additional information for a surgeon. The main observer camera 2 has a zoom system 6 (in particular a pancratic lens or varifocal lens) having different magnification levels.

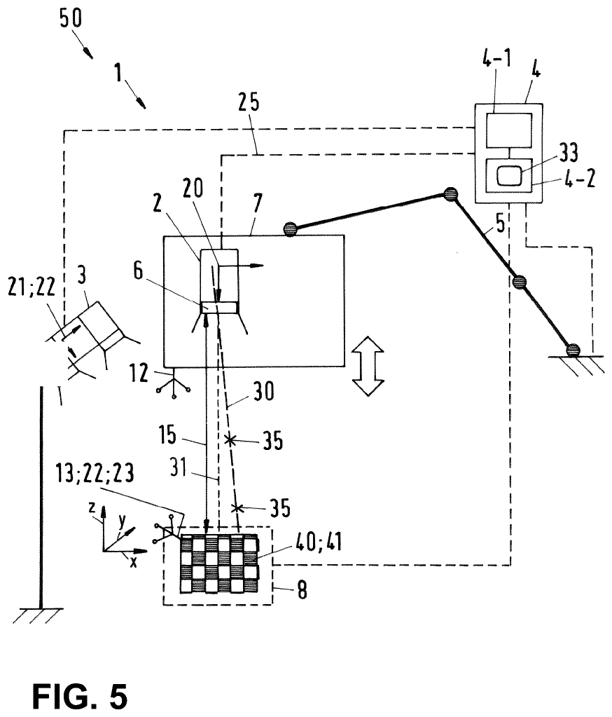

The environment camera 3 is configured for at least partly capturing the capture region 10 and an environment 11 of the capture region 10, wherein the environment camera 3 is used for tracking objects. As a result, the environment camera 3 always also captures objects and/or features of the objects arranged in the capture region 10 of the main observer camera 2. A coordinate system 21 of the environment camera 3 forms a reference coordinate system 22. As an alternative thereto, a coordinate system of an optical marker can form the reference coordinate system 22 (cf. variant in FIG. 5). In particular, objects in the capture region 10 of the main observer camera 2, that is to say in particular objects and/or features in the surgical area to be imaged, and also in the environment 11 of the capture region 10 are tracked with reference to the reference coordinate system 22 with the environment camera 3 in a manner known per se. As a result, a position of the objects and/or features in the reference coordinate system 22 is known.

The main observer camera 2 has an optical axis 30. A course of the optical axis 30 is ideally known and is described as a model-based optical axis 31 with a model in a reference coordinate system 22. Ideally, that is to say with correct extrinsic calibration of the main observer camera 2 and the environment camera 3 with respect to one another, the model-based optical axis 31 is identical to the (real) optical axis 30 of the main observer camera 2. Changes may occur, however, on account of external influences (impacts, temperature fluctuations, . . . ) and internal influences (mechanical tolerances, wear, . . . ), with the result that the extrinsic calibration is no longer correct. The model-based optical axis 31 and the (real) optical axis 30 of the main observer camera 2 are then no longer identical and an angular error 34 arises, as is indicated schematically in FIG. 1. This angular error 34 has the effect that objects imaged in captured image representations 25 with the main observer camera 2 are provided with incorrect coordinates in the reference coordinate system 22. The situation illustrated in FIG. 1 usually constitutes the initial situation for the method described in this disclosure.

The environment camera 3 likewise has an optical axis 32, although the latter is shown only for the sake of completeness and will not be considered further since the coordinate system 21 of the environment camera 3 forms the reference coordinate system 22 and the optical axis 32 therefore does not need to be known.

The control device 4 includes a computing device 4-1, for example a microprocessor, and a memory 4-2. The control device 4 is configured to implement and/or instigate essential measures of the method described in this disclosure.

The medical microscope 1 furthermore has an actuator system 5, which can alter in particular a working distance 15 of the main observer camera 2 and of the environment camera 3 with respect to an object (usually referred to as the z-direction). For this purpose, the main observer camera 2 and the environment camera 3 can be arranged in a common housing 7. Provision can be made for the actuator system 5 also to make possible a movement perpendicular thereto (i.e., in x-, y-directions).

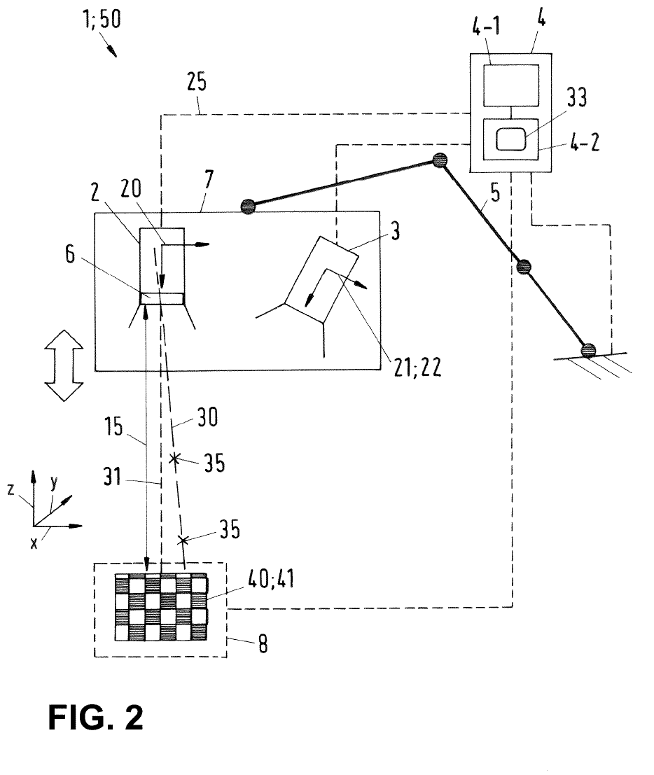

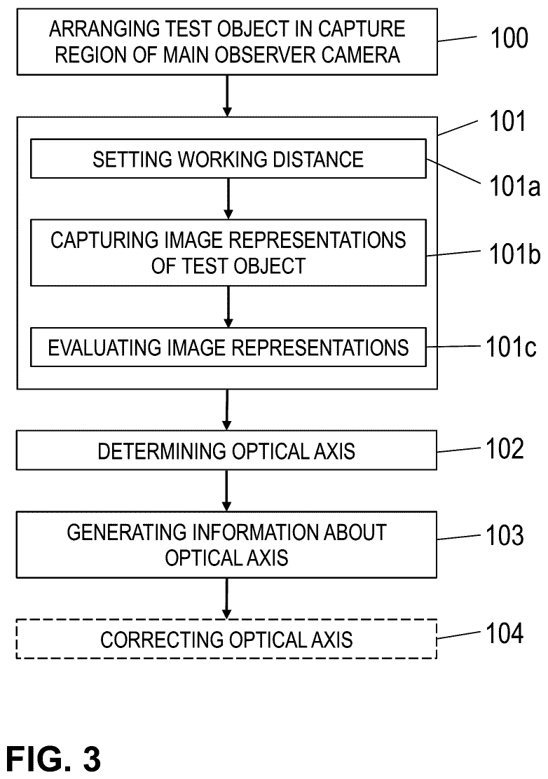

The control device 4 is configured to implement and/or instigate essential measures of the method described in this disclosure. This will be explained schematically with reference to FIGS. 2 and 3. The exemplary embodiment shown in FIG. 2 is configured like the exemplary embodiment shown in FIG. 1; the same reference signs denote the same features and terms. The actuator system 5 is configured here as a robotic stand. FIG. 3 shows a schematic flowchart of one exemplary embodiment of the method.

In a method step 100 (FIG. 3), a test object 40 is arranged in the capture region 10 of the main observer camera 2. Provision can be made for the test object 40 to be moved into the capture region 10 and arranged their manually or in an automated manner with an actuator system. Alternatively, a robotic surgical microscope can move independently over the test object. The test object can be fixedly connected to its stand in one case. The test object 40 includes a checkered pattern and/or a ChArUco pattern, for example. The test object 40 can be captured by the main observer camera 2 and the environment camera 3. The environment camera 3 tracks the test object 40 and can track for example a position and orientation of the test object 40 and/or of features of the test object 40, for example of edges and/or corners of fields of the checkered pattern, such that the positions and orientations thereof in the reference corner system 22 are known.

In a method step 101, the test object 40 is captured at at least two working distances with the main observer camera 2 and the environment camera 3, wherein at the at least two working distances 15 a neutral point 35 of the zoom system 6 of the main observer camera 2 is in each case determined in the coordinate system 21 of the environment camera 3.

For this purpose, the method step 101 includes the method steps 101a, 101b and 101c. In method step 101a, the actuator system 5 is controlled with the control device 4 in such a way that one of the at least two working distances 15 is set. This is done by the main observer camera 2 and the environment camera 3 being moved in the z-direction. This can be done manually or in an automated manner. In a method step 101b, image representations 25 of the test object 40 are captured at different magnifications of the zoom system 6 of the main observer camera 2. In method step 101c, the image representations 25 captured at the respective working distance 15 are evaluated. In the context of the evaluation, in particular, features of the test object 40 are recognized in the captured image representations 25. Since positions of the features are known on account of the tracking in the reference coordinate system 22, the features in the captured image representations 25 can be located in the reference coordinate system 22. In particular, the features in the captured image representations 25 can each be assigned coordinates in the reference coordinate system 22. With the image representations 25 captured at the different magnification levels, it is possible to determine the neutral point 35 for the working distance 15 considered. In this case, the neutral point 35 can be located in each of the captured image representations 25 with reference to the recognized features, such that a relative position of the neutral point 35 with respect to the features in the captured image representations 25 is known for the respective working distance. Proceeding from the respective relative position and the position known for the features in the reference coordinate system 22, it is possible to determine a position of the neutral point 35 in the reference coordinate system 22.

The method steps 101a, 101b and 101c are repeated until the method steps have been run through for all of the at least two working distance is 15.

In a method step 102, the optical axis 30 of the main observer camera 2 is determined proceeding from the neutral points 35 determined in the coordinate system 21 of the environment camera 3.

In a method step 103, at least one item of descriptive information 33 is generated which describes the optical axis 30 in the reference coordinate system 22 that has been determined. The descriptive information 33 can include for example a set of the positions of the neutral points 35 or parameters of a (sectional) straight-line equation in the reference coordinate system 22.

In particular, provision is made for the model-based optical axis 31 subsequently to be corrected with the aid of the at least one item of descriptive information 33 in a method step 104, such that said axis lies (again) on the (real) optical axis 30.

It can be provided that for capturing purposes the actuator system 5 of the medical microscope 1 is controlled or regulated in such a way that a position of a model-based optical axis 31 of the main observer camera 2 at a respective working distance 15 is arranged at a distinguished position of the test object 40, 41, wherein during the evaluating a difference between the distinguished position and the neutral point 35 determined for the respective working distance 15 is determined and taken into account when generating the at least one item of descriptive information 33. A distinguished position is a feature of the test object 40 that can be recognized particularly well, for example a corner point of a field of a checkered pattern, etc.

It can be provided that image representations 25 captured at the different magnifications at the respective working distance 15 for the purpose of determining the neutral point 35 are superimposed, wherein the neutral point 35 is determined as that point in the superimposed image representations 25 which moves the least between the image representations 25.

It can alternatively or additionally be provided that for the purpose of determining the neutral point 35, an optical flow between the image representation 25 captured at the different magnifications at the respective working distance 15 is determined and evaluated, wherein the neutral point 35, proceeding from the determined optical flow, is determined as that point in the image representations 25 which moves the least. The optical flow is determined with the aid of methods known per se.

It can be provided that the neutral points 35 determined for the at least two working distances 15 are connected with the aid of a line of best fit or a polynomial function, wherein the at least one item of descriptive information 33 describing the optical axis 30 includes parameters of the line of best fit or polynomial function.

It can be provided that positions on the optical axis 30 for non-measured working distances 15 are estimated by interpolation and/or extrapolation. In the simplest case, this is done with linear interpolation or extrapolation. In principle, however, a nonlinear interpolation or nonlinear extrapolation can also be used.

It can be provided that the test object 40 is displayed as a virtual test object 41 on a display device 8, in particular a display device 8 of the medical microscope 1. In this case, it can be provided that in method step 100 (FIG. 3), instead of arranging the (physical) test object 40 in the capture region 10 of the main observer camera 2, the virtual test object 41 is displayed on the display device 8 and the main observer camera 2 and the environment camera 3, in particular in the common housing 7, are arranged with the actuator system 5 in such a way that these can capture the virtual test object 41 displayed on the display device 8. The displaying is instigated in particular with the control device 4, which for this purpose correspondingly controls the display device 8 and provides image data for the virtual test object 41, for example image data for a checkered pattern or a ChArUco pattern.

Provision can be made for a position of the neutral point 35 to be monitored at least in the manner of random sampling during use of the zoom system 6. For this purpose, during a regular use of the zoom system 6, upon passing through different magnification levels, respective image representations 25 are captured and correspondingly evaluated for a feature arranged in the capture region 10 instead of the test object 40. In this case, the procedure is in principle analogous to the procedure that has been described for the method steps 101a, 101b and 101c.

Provision can be made for monitoring the extrinsics from the reference coordinate system to the main observer, i.e., in particular a relative pose between a coordinate system of the main observer camera and a coordinate system of the environment camera, during operation. If the pose of an object in the reference coordinate system is known, features can be projected into the image representations of the main observer and can be compared with the actual positions of the features in the image representations. If an offset is present, the axes have tilted with respect to one another or one of the axes was displaced parallel. A renewed calibration can then be requested.

With the aid of the medical microscope arrangement 50 or the medical microscope 1 and the method, a position of the optical axis 35 can be checked and corrected in the field. As a result, an extrinsic calibration between the main observer camera 2 and the environment camera 3 can be improved, which in turn leads to an improved correspondence of positions of objects and/or features captured by the main observer camera 2 and provided tracking information (tracking data) provided by the environment camera 3. Overall, a visualization and working with the medical microscope 1 can be improved as a result.

One exemplary embodiment can provide for capturing and evaluating image representations 25 of the test object 40, 41 at different magnifications of the zoom system 6 only at one working distance 15. At other working distances 15, in particular, only one magnification is employed in the context of the method. This can be carried out for example with a medical microscope arrangement 50 such as is shown in FIG. 1. Proceeding from the neutral point 35 determined at the working distance 15 by way of a zoom center, the optical axis 30 is determined.

For this purpose, it is provided that the optical axis 30 is determined at at least one further working distance 15 proceeding from the neutral point 35 determined at the working distance 15, on the basis of a pixel coordinate of the main observer camera 2 that corresponds to this neutral point 35 at the at least one working distance 15. If, when determining the neutral point 35 by way of the different magnification levels, for example a pixel coordinate of (250, 250) was determined, proceeding therefrom for a different working distance 15 it is subsequently possible to determine which feature in a captured image representation 25 is located at this pixel coordinate. This feature identified in this way is then likewise captured with the environment camera 3 and the position thereof in the coordinate system 21 of the environment, 3 is determined. The position determined in this way then forms a point on the optical axis 30.

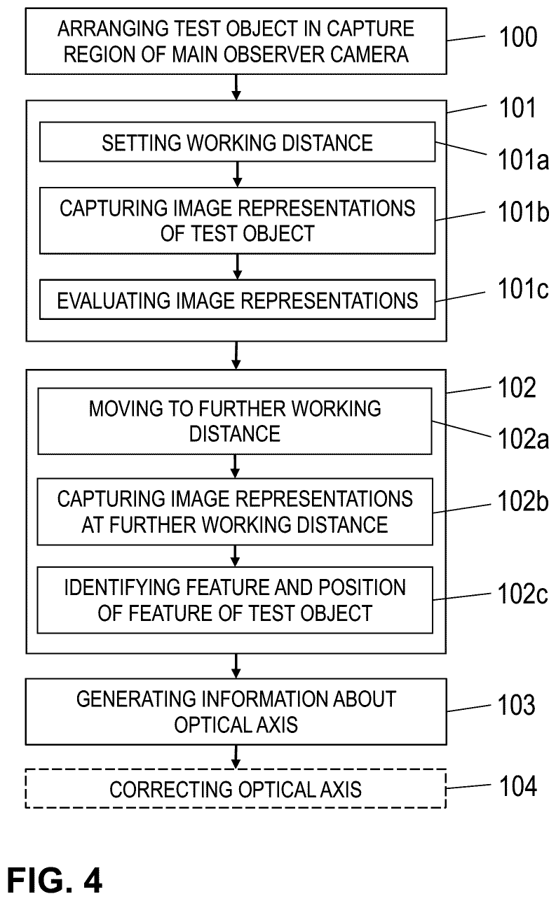

FIG. 4 shows a schematic flowchart of this exemplary embodiment of the method. In a method step 100, a test object 40 is arranged in the capture region 10 of the main observer camera 2. The test object 40 includes a checkered pattern and/or a ChArUco pattern, for example. The test object 40 can be captured by the main observer camera 2 and the environment camera 3. The environment camera 3 tracks the test object 40 and can track for example a position and orientation of the test object 40 and/or of features of the test object 40, for example of edges and/or corners of fields of the checkered pattern, such that the positions and orientations thereof in the reference corner system 22 are known.

In a method step 101, the test object 40 is captured at a working distance 15 with the main observer camera 2 and the environment camera 3, wherein at the working distance 15 a neutral point 35 of the zoom system 6 of the main observer camera 2 is determined in the coordinate system 21 of the environment camera 3.

For this purpose, the method step 101 includes the method steps 101a, 101b and 101c. In method step 101a, the actuator system 5 is controlled with the control device 4 in such a way that the working distance 15 is set. This is done by the main observer camera 2 and the environment camera 3 being moved in the z-direction. In a method step 101b, image representations 25 of the test object 40 are captured at different magnifications of the zoom system 6 of the main observer camera 2. In method step 101c, the image representations 25 captured at the working distance 15 are evaluated. In the context of the evaluation, in particular, features of the test object 40 are recognized in the captured image representations 25. Since positions of the features are known on account of the tracking in the reference coordinate system 22, the features in the captured image representations 25 can be located in the reference coordinate system 22. In particular, the features in the captured image representations 25 can each be assigned coordinates in the reference coordinate system 22. With the image representations 25 captured at the different magnification levels, it is possible to determine the neutral point 35 for the working distance 15 considered. In this case, the neutral point 35 can be located in each of the captured image representations 25 with reference to the recognized features, such that a relative position of the neutral point 35 with respect to the features in the captured image representations 25 is known for the working distance 15. Proceeding from the respective relative position and the position known for the features in the reference coordinate system 22, it is possible to determine a position of the neutral point 35 in the reference coordinate system 22 for the working distance 15.

Furthermore, proceeding from the captured image representations 25, a pixel coordinate of the neutral point 35 is determined, that is to say that that pixel coordinate at which the neutral point 35 is located in the image representations 25 is identified. It is assumed that the optical axis 30 is always located at this determined pixel coordinate at other working distances 15 as well.

In a method step 102, the optical axis 30 of the main observer camera 2 is determined proceeding from the neutral point 35 determined in the coordinate system 21 of the environment camera 3 for the one working distance 15. In particular, the previously identified pixel coordinate is used for this purpose. For this purpose, the method step 102 includes the method steps 102a, 102b and 102c. In method step 102a, a further working distance 15 is moved to. In method step 102b, an image representation 25 is captured at the further working distance 15. In method step 102c, a feature of the test object 40 which is arranged at the position of the identified pixel coordinate is identified in the captured image representation and a position of this feature in the coordinate system 21 of the environment camera 3 is determined. By way of this, a neutral point 35 can be determined for this working distance 15. The method steps 102a, 102b and 102c can be repeated in the same way for other working distances 15.

In a method step 103, at least one item of descriptive information (33) describing the determined optical axis (30) in the reference coordinate system is generated and provided. The descriptive information 33 can include for example a set of the positions of the neutral points 35 determined for the working distances 15 or parameters of a (sectional) straight-line equation in the reference coordinate system 22.

In particular, provision is made for the model-based optical axis 31 subsequently to be corrected with the aid of the at least one item of descriptive information 33 in a method step 104, such that said axis lies (again) on the (real) optical axis 30.

FIG. 5 shows a further exemplary embodiment of the medical microscope arrangement 50. In this exemplary embodiment, provision is made for the medical microscope arrangement 52 which includes a medical microscope 1 and a navigation system 9, wherein the environment camera 3 is part of the navigation system 9. With the navigation system 9, optical markers 12, 13 arranged on the housing 7 or on a stand of the microscope 1 and respectively on the test object 40 can be captured and their pose (position and orientation) in the coordinate system 21 can be determined. The procedure for determining the optical axis is in principle the same as that already described for the other exemplary embodiments.

If the test object 40 is captured by the environment camera 3, the reference coordinate system 22 can be a coordinate system 23 of the optical marker 13, that is to say that, in particular, the pose of the marker 13 with respect to the optical axis 30 of the main observer camera or the pose of the optical axis 30 with respect to the pose of the marker 13 is determined.

### LIST OF REFERENCE NUMERALS

1 medical microscope
2 main observer camera
3 environment camera
4 control device
4-1 computing device
4-2 memory
5 actuator system
6 zoom system
7 housing
8 display device
9 navigation system
10 capture region
11 environment
12 optical marker (microscope)
13 optical marker (test object)
15 working distance
20 coordinate system (main observer camera)
21 coordinate system (environment camera)
22 reference coordinate system
23 coordinate system (optical marker)
25 image representation
30 (real) optical axis
31 model-based optical axis
32 optical axis (environment camera)
33 descriptive information
34 angular error
35 neutral point
40 test object
41 virtual test object
50 medical microscope arrangement
100-104 method steps of the method

What is claimed is:

1. A method for determining an optical axis of a main observer camera of a medical microscope arrangement in a reference coordinate system, the method comprising:
capturing a capture region with a main observer camera;
capturing the capture region at least partly and an environment of the capture region with an environment camera; and
generating and providing at least one item of descriptive information describing the optical axis in the reference coordinate system,
wherein the environment camera is configured to track objects,
wherein a first coordinate system of the environment camera or a second coordinate system of an optical marker forms the reference coordinate system,
wherein a test object is captured at at least one working distance with the main observer camera and the environment camera,
wherein at the at least one working distance a neutral point of a zoom system of the main observer camera is determined in the first coordinate system of the environment camera by capturing and evaluating image representations of the test object at different magnifications of the zoom system at the at least one working distance, and
wherein the optical axis of the main observer camera is determined proceeding from the neutral point determined in the first coordinate system of the environment camera at the at least one working distance.

2. The method as claimed in claim 1, further comprising:
determining the optical axis at at least one further working distance proceeding from the neutral point determined at the at least one working distance based on a pixel coordinate of the main observer camera that corresponds to the neutral point at the at least one working distance.

3. The method as claimed in claim 1, further comprising:
capturing a test object at at least two working distances with the main observer camera and the environment camera;
determining at the at least two working distances the neutral point of the zoom system of the main observer camera in each case in the first coordinate system of the environment camera by capturing and evaluating image representations of the test object at different magnifications of the zoom system at each of the working distances;
determining the optical axis of the main observer camera proceeding from the neutral point determined in the first coordinate system of the environment camera; and
generating and providing the at least one item of the descriptive information describing the determined optical axis in the reference coordinate system.

4. The method as claimed in claim 1, further comprising:
controlling an actuator system of the medical microscope arrangement to capture the capture region such that a position of a model-based optical axis of the main observer camera at the at least one working distance is arranged at a distinguished position of the test object,
wherein during the evaluating a difference between the distinguished position and the neutral point determined for the at least one working distance is determined and taken into account when generating the at least one item of the descriptive information.

5. The method as claimed in claim 1, further comprising:
superimposing image representations captured at the different magnifications at the at least one working distance to determine the neutral point; and
determining the neutral point as the point in the image representations which moves the least between the image representations.

6. The method as claimed in claim 1, wherein to determine the neutral point, an optical flow between the image representations captured at the different magnifications at the at least one working distance is determined and evaluated, and
wherein the neutral point, proceeding from the optical flow, is determined as the neutral point in the image representations which moves the least.

7. The method as claimed in claim 1, wherein neutral points determined for at least two working distances are connected by a line of best fit or a polynomial function, and
wherein the at least one item of descriptive information describing the optical axis includes parameters of the line of best fit or polynomial function.

8. The method as claimed in claim 1, wherein positions on the optical axis for non-measured working distances are estimated by at least one of interpolation and extrapolation.

9. The method as claimed in claim 1, wherein the test object is displayed as a virtual test object on a display device.

10. The method as claimed in claim 1, wherein the test object includes at least one of a checkered pattern and a ChArUco pattern.

11. The method as claimed in claim 1, wherein a position of the neutral point at a working distance is monitored at least in a manner of random sampling during use of the zoom system.

12. A medical microscope arrangement, comprising:
a main observer camera having a zoom system, and being configured to capture a capture region;
an environment camera configured to at least partly capture the capture region and an environment of the capture region, wherein the environment camera is configured to track objects, and wherein a first coordinate system of the environment camera or a second coordinate system of an optical marker forms a reference coordinate system,
an actuator system configured to move at least the main observer camera, and
a control device configured to:
instigate capturing of a test object at at least one working distance with the main observer camera and the environment camera, and
control the actuator system and the zoom system of the main observer camera such that at the at least one working distance a neutral point of the zoom system of the main observer camera can be determined in the first coordinate system of the environment camera by capturing and evaluating image representations of the test object at different magnifications of the zoom system;
determine an optical axis of the main observer camera proceeding from the neutral point determined at the at least one working distance in the first coordinate system of the environment camera; and
generate and provide at least one item of descriptive information describing the determined optical axis in the reference coordinate system.
